(19) United States
(12) Patent Application Publication
(10) Pub. No.: US 2003/0155222 A1
(43) Pub. Date: Aug. 21, 2003

(54) Switch interlock apparatus

(76) Inventor: Paul Schnackenberg, Roswell, GA (US)

Correspondence Address: GREENBERG TRAURIG, P.C., 77 WEST WACKER DRIVE, CHICAGO, IL, 60601-1732, US

(21) Appl. No.: 10/078,039

(22) Filed: Feb. 19, 2002

(51) Int. Cl. H01H 9/26

(52) U.S. Cl. 200/50.32

(57) ABSTRACT

A switch interlock apparatus for use with switch panels, having pairs of functionally related switches, in which the handles for the switches are aligned with their pivot axes parallel to one another, in which one of the switches must be flipped, before the other switch can be flipped. The switch interlock apparatus mechanically connects the handles of two functionally related switches so that as one switch moves from an “OFF” to an “ON” position, the interlock constrains the handle of the related paired switch to move from “ON” to “OFF” first. In a preferred embodiment, the switch interlock apparatus incorporates a monolithically formed interlock member that can be directly mounted to a switch panel without intermediate assembly steps.

### BACKGROUND OF THE INVENTION

1. Field of the Invention

The present invention relates to switch interlock apparatus, such as are used with switch panels, like electrical breaker switch panels, wherein the switches are arrayed in pairs.

2. The Prior Art

Switching apparatus, such as breaker switch panels, that have switches that are arrayed in pairs, are known. Typically, the individual switches in such switch apparatus are laid out in such a manner that switches that are connected to related circuits are arranged in horizontal pairs, wherein in order to accomplish a particular switching operation, it is either desirable or absolutely necessary that one switch be flipped (opened or closed) before a second switch of a functional pair is flipped (closed or opened). Together, such a switch functional pair is often referred to collectively as a “break-before-make” switch.

One such environment in which such “break-before-make” switch combinations are used is a transfer switch panel. Transfer switches are switches or groups of switches that are used to convert a powered circuit, such as a residential or commercial structure, from one source of electrical current, to another source of current. One typical example is a residential structure that is provided with an independently powered back-up electrical generator. A transfer switch or switch panel will be connected to the household circuits, the utility power connection, and to the input from the generator.

If the transfer switch is manual, upon failure of the utility power, an operator will flip the transfer switches, disconnecting the utility current source from the household circuitry and connecting the back-up generator to the household circuitry. The generator is then started (or may have already been started) and back-up current is supplied to the residence.

If the transfer switch is of the automatic type, it will monitor various characteristics of the utility power being supplied, and if one or more of the characteristics falls below a predetermined numerical value, a similar sequence of switches will be automatically flipped through an automated mechanism, and the generator (if provided with an electric starter circuit) will be automatically started.

For manual transfer switches, typically, physically separate switches are used for each functional switch pair, in two columns of switches. Typically, such switches are biased, so that once a switch handle has reached top dead center, any slight deflection from that position, will cause the switch to continue to the full switched position on that “side” of top dead center, unless otherwise restrained.

The reason that separately acting switches are used is to ensure that the utility current circuitry is disengaged before the power is applied, to prevent power from being fed back into the utility current source circuit, potentially causing substantial damage to utility equipment and/or personal injury. In addition, typically, the polarities of the switches in the respective columns are reversed. For example, in a switch panel having two columns of switches, the individual switches of one column of switches must be flipped first before the corresponding individual switches of the column of switches can be flipped. For example, in the left-hand column, which may be the switches for connecting the back-up generator circuit to the household circuit, the “ON” positions for the switch handles will be on the right and the “OFF” positions for the switch handles will be on the left. In the right-hand column, which may be the switches for connecting the line/utility circuit to the household circuit, the “OFF” positions will be to the right, and the “ON” positions will be to the left. In such an arrangement, the switches on the right must be flipped before the corresponding ones on the left can be safely flipped. However, there may be a tendency for an operator to make a single left-to-right hand movement would flip all the left column switches from “ON” to “OFF”, and then flip all the right column switches from “OFF” to “ON”. In such a situation, the order of switching would be improper, and could lead to damage or personal injury.

Therefore it has been determined that it is not only desirable but necessary to ensure that the switches engaging the generator to the household circuit cannot be flipped, before the line/utility is disconnected from the household circuit. By advantageously connecting the switch handles together, it is ensured that if a generator switch is flipped, the corresponding line/utility switch will be flipped first.

Interlock devices for connecting the handles of such functional pairs of switches are known. One such device is disclosed in Flegel, U.S. Pat. No. 6,031,193. The apparatus that is disclosed in the Flegel '193 patent comprises two flat metal plates that are connected together by a “U”-shaped metal piece that has two upturned ends. The bottom of the “U” has a series of holes through which screws may be passed, and in turn, passed through holes in the ends of the two flat metal plates (for adjustability). The distance between the upturned ends (stops) of the U-shaped metal piece is about the distance between the inside faces of the switches, when one is in the “OFF” position and the other is in the “ON” position. The interlock is assembled in place, with the two flat bars being slid through recesses or apertures beneath the cross bars of the individual opposed switch handles, and then connected to each other via the “U”-shaped component. Screws are placed in holes in the opposite ends of the interlock (to the outside of the two switches), the ends of which are intended to ride in slots (presumably already provided in the face of the switch panel) between the pairs of tandem switches, as an additional guide arrangement. The stops on the U-shaped metal piece are spaced so that when a switch in the “OFF” position is being moved toward the “ON” position, the switch in the “ON” position is moved to top dead center and then into its over-center position and switches, under bias, to “OFF” before the first switch arrives at its respective “ON” position.

However, such a design has several potential limitations. First, it must be assembled in place from component parts, thus making it somewhat awkward and labor intensive to install. Second, it requires that each of the switch handles actually be a tandem (side-by-side) handle, so that there is a gap or hole, through which the main bar of the interlock has to be passed. Third, the design requires the presence of a groove or rail, into which the ends of the screws are received, to act as a guide for the reciprocating movement of the interlock apparatus.

It would be desirable to provide a switch interlock apparatus that has a simplified structure that does not require assembly of numerous component parts.

It would also be desirable to provide a switch interlock apparatus that can be pre-assembled prior to mounting to a switch panel.

It would also be desirable to provide a switch interlock apparatus that does not depend upon structural features of the switch panel to which it is being mounted, such as a groove or rail, for functionality.

These and other desirable characteristics of the present invention will become apparent in view of the present specification, including claims, and drawings.

### SUMMARY OF THE INVENTION

The present invention is directed to a switch interlock apparatus, for mechanically connecting the handles of functionally and physically paired switches on a switch panel. The switch interlock apparatus comprise an elongated interlock member, having a longitudinal axis and first and second ends. At least one fastener structure is disposed on the elongated interlock member, for enabling slidable connection of the elongated interlock member to a switch panel. A switch handle receiving contour is disposed at each of the first and second ends of the elongated interlock member. A switch handle engagement surface is disposed within each switch handle receiving contour.

In a preferred embodiment of the invention, the switch interlock apparatus further comprises guide structure, operably associated with the at least one fastener structure, for constraining the slidable movement of the elongated interlock member to linear reciprocating movement.

In a preferred embodiment of the invention, the at least one fastener structure comprises at least one aperture through the elongated interlock member, for accommodating the passage of a fastener therethrough. When a guide structure is provided, in a preferred embodiment of the invention, the guide structure comprises the at least one aperture being formed as an elongated slot extending parallel to the longitudinal axis of the elongated interlock member.

Preferably, the switch handle receiving structure disposed at each end of the elongated interlock member comprises a substantially rectangular notch.

Preferably, the distance between the switch handle engagement surfaces is less than an inside-to-inside distance between the handles of functionally and physically paired switches on a switch panel.

Preferably, the elongated interlock member is monolithically formed from a single piece of material. In an embodiment of the invention, the elongated interlock member is formed from metal. In another embodiment of the invention, the elongated interlock member is formed from plastic.

In another embodiment of the invention, the switch interlock apparatus may further comprise a lateral stabilization contour disposed between the first and second ends of the elongated interlock member. The lateral stabilization contour may comprise a ridge extending transversely across the elongated interlock member, substantially perpendicular to the longitudinal axis. Alternatively, the lateral stabilization contour comprises at least two longitudinally extending ridges emanating from the elongated interlock member and extending substantially parallel to the longitudinal axis.

### BRIEF DESCRIPTION OF THE DRAWINGS

FIG. 1 is a top plan view of a switch interlock apparatus according to one embodiment of the invention.

FIG. 2 is a side elevation of the switch interlock apparatus according to the embodiment of FIG. 1.

FIG. 3 is a perspective view of the switch interlock apparatus according to the embodiment of FIGS. 1-2.

FIG. 4 is a side elevation of the switch interlock apparatus according to the embodiment of FIGS. 1-3, showing the switch interlock apparatus in position on a switch panel, in first and second positions relative thereto.

FIG. 5 is a top plan view of a switch interlock apparatus according to a second embodiment of the invention.

FIG. 6 is a side elevation, partially in section, of the switch interlock apparatus according to the embodiment of FIG. 5, taken along line C-C of FIG. 5.

FIG. 7 is an end view, in section, of the switch interlock apparatus according to the embodiment of FIGS. 5-6, taken along line A-A of FIG. 5.

FIG. 8 is an end view, in section, of the switch interlock apparatus according to the embodiment of FIGS. 5-7, taken along line B-B of FIG. 5.

FIG. 9 is a top perspective view of the switch interlock apparatus according to the embodiment of FIGS. 5-8.

FIG. 10 is a bottom perspective view of the switch interlock apparatus according to the embodiment of FIGS. 5-9.

FIG. 11 is a front elevation of a switch panel having four switch interlock apparatus, according to the embodiment of FIGS. 5-10, mounted thereon.

FIG. 12 is a side elevation, partially in section, showing one of the switch interlock apparatus, according to the embodiment of FIGS. 5-11, taken along line A-A of FIG. 11, showing the paired switches in their two respective paired positions.

### DETAILED DESCRIPTION OF THE DRAWINGS

While this invention is susceptible of embodiment in many different forms, there is shown in the drawings and will be described in detail, two specific embodiments, with the understanding that the present disclosure is to be considered as an exemplification of the principles of the invention and is not intended to limit the invention to the embodiment illustrated.

Any dimensions or other numerical values indicated in the Figures or in the description herein are by way of example, and the invention is not to be considered limited thereto.

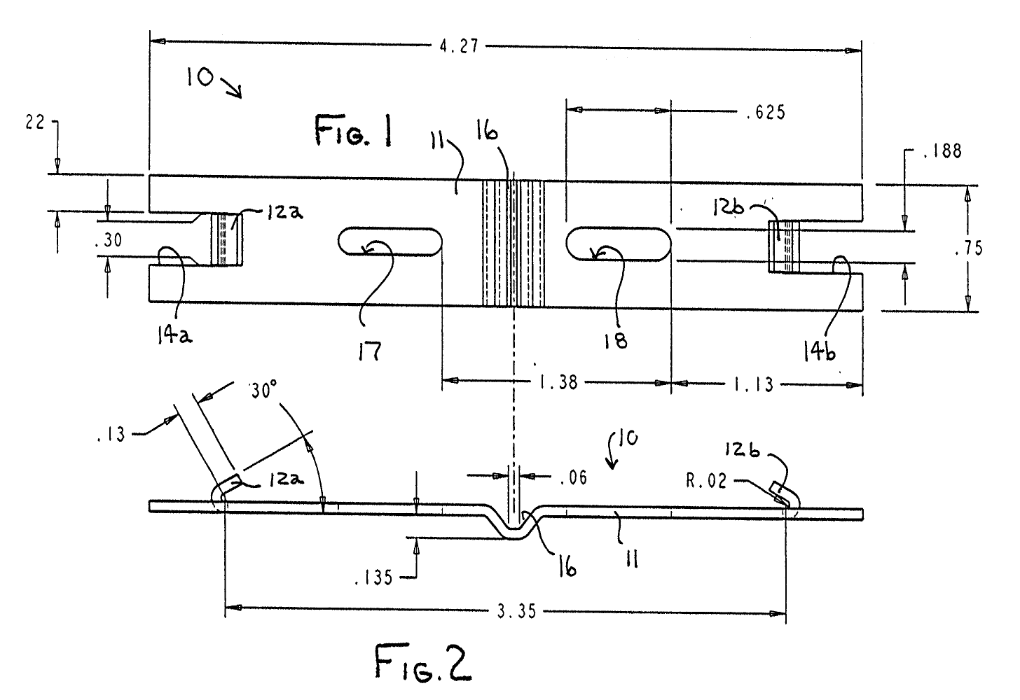

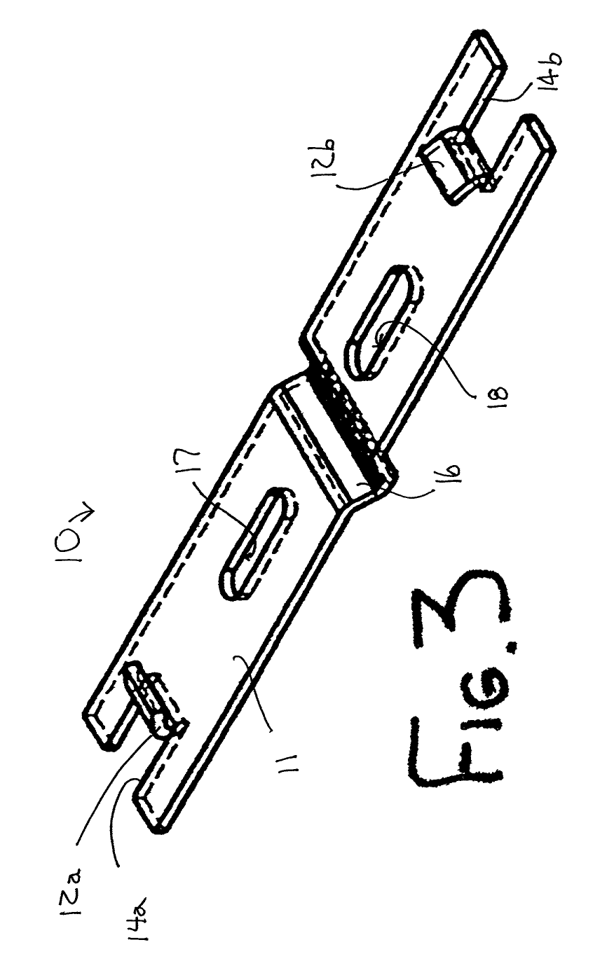

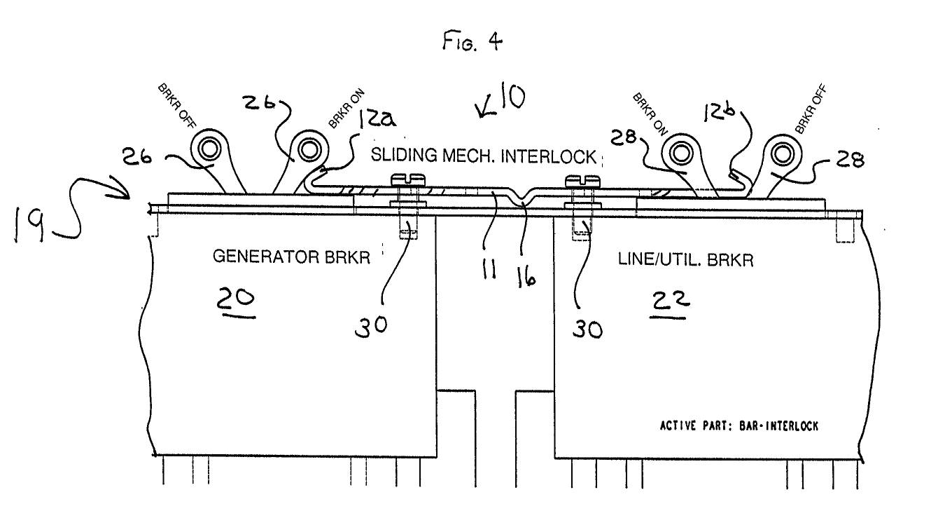

FIGS. 1-4 illustrate a first embodiment of the invention. FIG. 1 is a top plan view of a switch interlock apparatus according to one embodiment of the invention. FIG. 2 is a side elevation of the switch interlock apparatus according to the embodiment of FIG. 1. FIG. 3 is a perspective view of the switch interlock apparatus according to the embodiment of FIGS. 1-2. FIG. 4 is a side elevation of the switch interlock apparatus according to the embodiment of FIGS. 1-3, showing the switch interlock apparatus in position on a switch panel, in first and second positions relative thereto.

The first embodiment for switch interlock apparatus 10 comprises an originally flat elongated interlock member 11 that has a rectangular tab cut from each end, and curled upward to create a switch handle stop 12a, 12b and a rectangular notch 14a, 14b, one at each end of the elongated interlock member 11. Elongated interlock member 11 is preferably monolithically formed as a single piece of metal, preferably steel. Elongated interlock member 11 has been further deformed by the introduction of a generally V-shaped transverse ridge/notch 16. Ridge 16 provides for lateral stabilization of the elongated interlock member 11, so that it has less tendency to rock from side to side, during operation.

Referring to FIG. 4, two aligned switches 20, 22, e.g., circuit breakers for a transfer switch panel 19 (typically there are several such pairs of switches/circuit breakers), are mounted, in usual fashion, so that the “OFF” positions for the handles are to the outside of the pair of breakers and the “ON” positions are to the inside. Switch 20 has a single handle 26, which is shown in both its “OFF” (left) and “ON” (right) positions. Switch 22 has a single handle 28, which is shown in both its “ON” (left) and “OFF” (right) positions. The distance between the tabs 12a, 12b in the elongated interlock member 11 is actually slightly more than the inside face to inside face distance between switch handles 26, 28, when one switch is in the “OFF” position, and the other switch is in the “ON” position. The curled up portions of tabs 12a and 12b bear against the inside surfaces of the two aligned switch handles 26, 28. Slots 14a, 14b accommodate handles 26, 28, so that handles 26, 28 are surrounded by the portions of elongated interlock member 11 that are to the sides (or above and below, depending upon the orientation of the switch panel) of handles 26, 28. The portions of elongated interlock member 11 that are to the sides of handles 26, 28 are omitted from FIG. 4, for simplicity of illustration.

Elongated interlock member 11 has two longitudinally extending slots 17, 18. Each of switches 20, 22 will already have openings for receiving screws, as those will be the openings used for affixing the faces of the switches to the switch body, which is an industry standard construction. Elongated interlock member 11 is slidably mounted with respect to the face of the panel 19, by inserting one screw 30 through each slot, so that the elongated interlock member 11 is guided in its reciprocating movement by the screws 30 interacting with slots 17, 18. Stability and smoothness of movement is provided, in part, by transverse ridge/notch 16, as well as the flat portions of the ends of elongated interlock member 11, which rest directly against the portions of switches 20, 22, that are immediately adjacent handles 26, 28. Because notches 14a, 14b are open ended, this design does permit both switches to be in the “OFF” position, but not both in the “ON” position, because the distance between tabs 12a, 12b is less than the inside-to-inside distance between handles 26, 28. Typical switch panels usually have faces that are immediately adjacent the handles for functionally and physically paired switches, that are elevated with respect to the space or at least a portion of the space between the switches. When fastened to switch panel 19, the screws are used, not to press apparatus 10 hard again these face surfaces, but rather to generally keep apparatus 10 in close proximity, but with freedom of reciprocating linear movement between the handles of the switches.

Mounting of apparatus 10 is accomplished by simply flipping the handles of paired switches to their respective “OFF” positions (i.e., away from one another) ensuring of course, that the circuits are “dead” to avoid injury or damage, and fastening apparatus 10 using screws or machine bolts, into already existing or formed apertures.

FIGS. 5-12 illustrate a second preferred embodiment of the invention. Switch interlock apparatus 50 is preferably a monolithically-formed, molded plastic structure that otherwise has generally the same configuration as the first embodiment, in that it has two open notches at opposite ends of the molding, and two longitudinal slots for receiving and interacting with the mounting and guide screws.

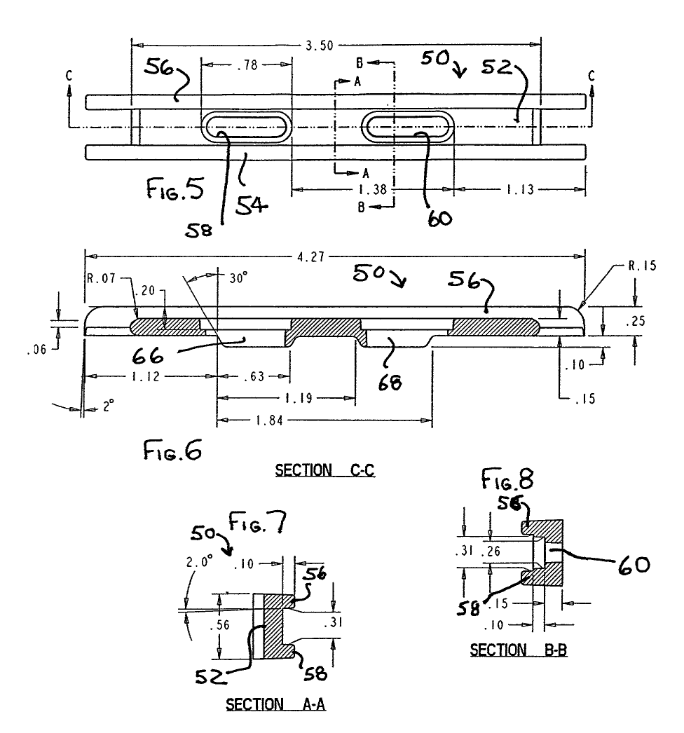

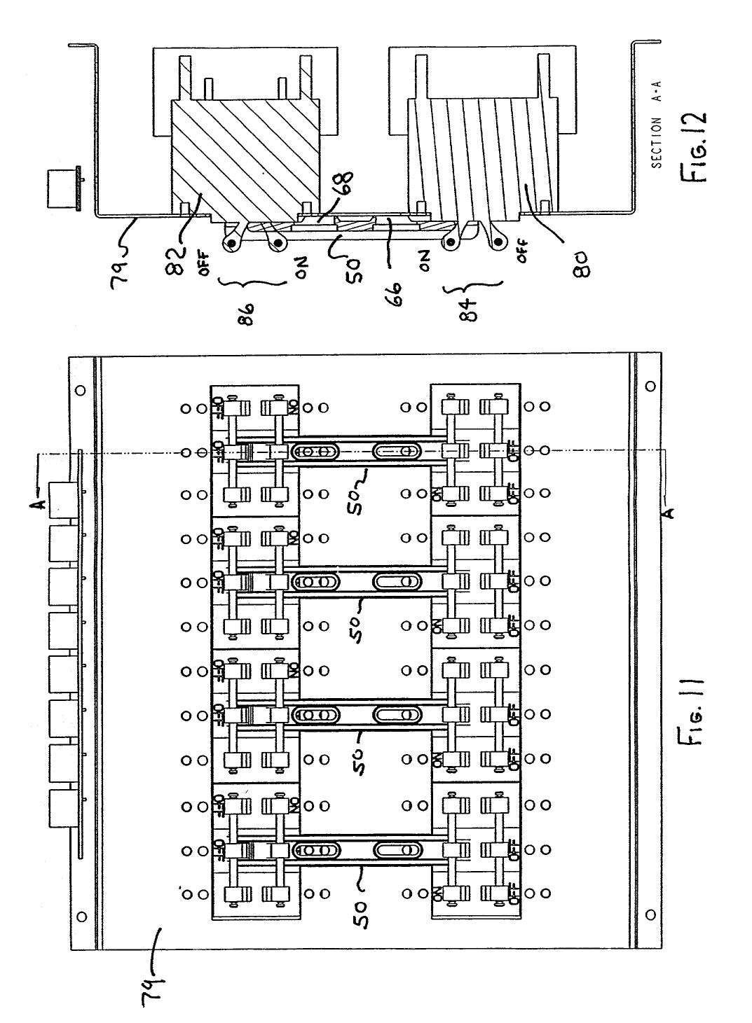

FIG. 5 is a top plan view of a switch interlock apparatus 50 according to a second embodiment of the invention. Preferably, switch interlock apparatus 50 is fabricated from a single piece of molded plastic material, such as flame resistant ABS or polycarbonate 94VO, or other similar material that has the characteristics of durability, fire resistance and UL (Underwriter's Laboratories) acceptability (a requirement for products for commercial or residential installation). Switch interlock apparatus 50 includes a central “horizontal” web 52, and two “vertical” side webs 54, 56. Two elongated slots 58, 60 are provided in web 52. Each of slots 58, 60 may have suitably formed inside surface contours, so that when switch interlock apparatus 50 is connected to a switch panel, e.g., by screws, the heads of the screws will be received in upper, widened portions of the slots, while the threaded portions of the screws will be received in lower, narrower portions of the slots. See, e.g., FIG. 8. Each of side webs 54, 56 includes two downwardly extending ridges, e.g., ridges 62, 64 of side web 54, and ridges 66, 68 (see FIG. 6) which serve to “elevate” switch interlock apparatus 50, so that the ridges contact the recessed portions of a switch panel 79 (see FIG. 11, 12), while the ends of switch interlock apparatus 50 are flush with the portions of the switches that are immediately adjacent the switch handles. Ridges 62, 64, 66, 68 provide for lateral stabilization of switch interlock apparatus 50, much as ridge 16 does for switch interlock apparatus 10. Ridges 62, 64, 66 and 68 also serve to “elevate” the ends of the interlock apparatus 50, in a manner similar to the way ridge 16 “elevates” the ends of apparatus 10.

Switch interlock apparatus 50 includes notches 70, 72 at its ends, with notch bottoms 74, 76, respectively. The distance between notch bottoms 74, 76 is, as in the embodiment of FIGS. 1-4, less than the inside-to-inside distance between paired switch handles, again, so that while the two handles can both be in the “OFF” position, two handles of paired switches cannot be in the “ON” position.

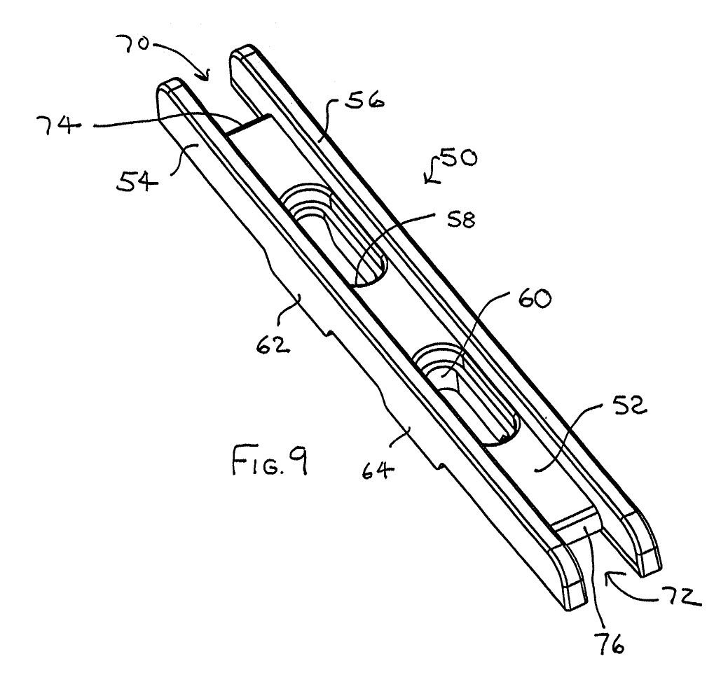

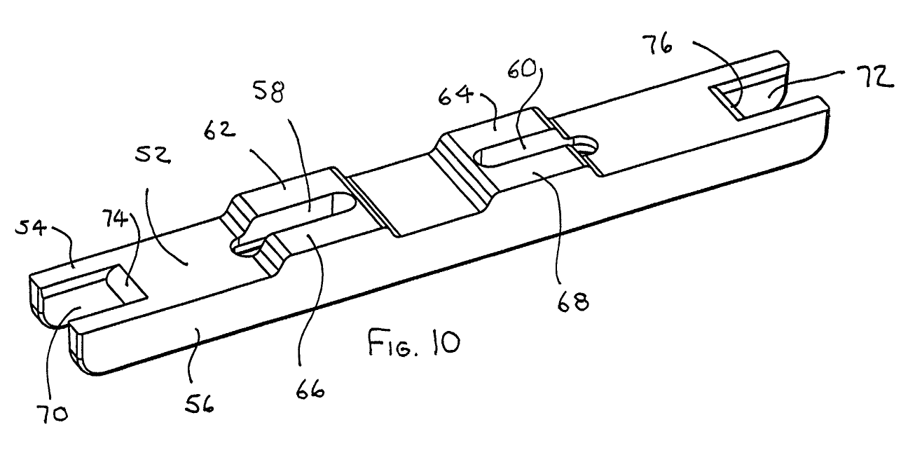

FIG. 6 is a side elevation, partially in section, of the switch interlock apparatus according to the embodiment of FIG. 5, showing, in further detail, the contours of the slots for receiving the mounting screws. FIG. 7 is an end view, in section, of the switch interlock apparatus according to the embodiment of FIGS. 5-6, taken along line A-A of FIG. 5, showing the general cross-section of the molding at a location between the screw slots. FIG. 8 is an end view, in section, of the switch interlock apparatus according to the embodiment of FIGS. 5-7, taken along line B-B of FIG. 5. FIG. 9 is a top perspective view of the switch interlock apparatus according to the embodiment of FIGS. 5-8, and showing, in particular, an end view of the contours of a screw slot.

FIG. 11 is a somewhat schematic front elevation of a switch panel 79 having four switch interlock apparatus 50, according to the embodiment of FIGS. 5-10, mounted thereon. FIG. 12 is a side elevation, partially in section, showing one of the switch interlock apparatus 50, according to the embodiment of FIGS. 5-11, taken along line A-A of FIG. 11, showing paired switches 80, 82, with their respective handles 84, 86 in their two respective paired positions.

The switch interlock apparatus of the present invention have several advantageous design features over the prior art. Each is, in a preferred embodiment of the invention, monolithically formed from a single piece of metal or plastic (although they may be formed from separate parts if desired, without departing from the scope of the invention). Furthermore, each design is capable of being mounted directly to a switch panel, without having to be assembled in situ, apart from the mounting screws. Mounting is simplified through the use of open-ended notches at the ends of the switch apparatus, by simply moving both switch handles of any given pair, to their respective “OFF” positions, and mounting the switch interlock apparatus. The individual switches may be positioned as desired.

The present invention is also useful, in the embodiment of an automatic transfer switch apparatus in that, through the use of powered relays, simplified breaker switches can be employed instead of more complex circuitry. For example, if the control circuitry of the automatic transfer switch detects an oncoming line/utility power failure, the control circuitry powers the relays on the “Generator” side to move toward the “ON” positions. Use of switch interlock apparatus according to the present invention, causes the counterpart line/utility circuit breakers to be tripped to “OFF”, before the generator breakers are flipped to “ON”. Conversely, if the automatic transfer switch control circuitry detects the restoration of line/utility power, the powered relays on the “Line/Utility” side of the panel will perform the reverse operation, to disengage the generator circuits before restoration of line/utility power to the household circuitry.

The foregoing description and drawings merely explain and illustrate the invention and the invention is not limited thereto except insofar as the appended claims are so limited, as those skilled in the art who have the disclosure before them will be able to make modifications and variations therein without departing from the scope of the invention.

1. A switch interlock apparatus, for mechanically connecting the handles of functionally and physically paired switches on a switch panel, the switch interlock apparatus comprising:
an elongated interlock member, having a longitudinal axis and first and second ends;
at least one fastener structure disposed on the elongated interlock member, for enabling slidable connection of the elongated interlock member to a switch panel;
a switch handle receiving contour disposed at each of the first and second ends of the elongated interlock member; and
a switch handle engagement surface, disposed within each switch handle receiving contour.

2. The switch interlock apparatus, according to claim 1, further comprising:
guide structure, operably associated with the at least one fastener structure, for constraining the slidable movement of the elongated interlock member to linear reciprocating movement.

3. The switch interlock apparatus, according to claim 2, wherein the at least one fastener structure comprises at least one aperture through the elongated interlock member, for accommodating the passage of a fastener therethrough.

4. The switch interlock apparatus, according to claim 3, wherein the guide structure comprises the at least one aperture being formed as an elongated slot extending parallel to the longitudinal axis of the elongated interlock member.

5. The switch interlock apparatus, according to claim 1, wherein the switch handle receiving structure disposed at each end of the elongated interlock member comprises a substantially rectangular notch.

6. The switch interlock apparatus, according to claim 1, wherein the distance between the switch handle engagement surfaces is less than an inside-to-inside distance between the handles of functionally and physically paired switches on a switch panel.

7. The switch interlock apparatus, according to claim 1, wherein the elongated interlock member is monolithically formed from a single piece of material.

8. The switch interlock apparatus, according to claim 1, wherein the elongated interlock member is formed from metal.

9. The switch interlock apparatus, according to claim 1, wherein the elongated interlock member is formed from plastic.

10. The switch interlock apparatus, according to claim 1, further comprising a lateral stabilization contour disposed between the first and second ends of the elongated interlock member.

11. The switch interlock apparatus, according to claim 10, wherein the lateral stabilization contour comprises a ridge extending transversely across the elongated interlock member, substantially perpendicular to the longitudinal axis.

12. The switch interlock apparatus, according to claim 10, wherein the lateral stabilization contour comprises at least two longitudinally extending ridges emanating from the elongated interlock member and extending substantially parallel to the longitudinal axis.
